(19) United States
(12) Patent Application Publication
(10) Pub. No.: US 2009/0142980 A1
(43) Pub. Date: Jun. 4, 2009

(54) MULTILAYER FABRIC

(75) Inventors: Jieng-Chiang CHEN, Chung-Li City (TW); Yu-Chih CHEN, Chung-Li City (TW)

Correspondence Address: SHERIDAN ROSS PC, 1560 BROADWAY, SUITE 1200, DENVER, CO, 80202, US

(73) Assignee: Jieng-Chiang CHEN, Chung-Li City (TW)

(21) Appl. No.: 12/194,113

(22) Filed: Aug. 19, 2008

(30) Foreign Application Priority Data
Dec. 3, 2007 (TW) 096145898

(51) Int. Cl. B32B 5/26

(52) U.S. Cl. 442/239

(57) ABSTRACT

A multilayer fabric includes a multilayer structure including a plurality of interwoven fabric layers. The multilayer structure is expandable in a first direction from a non-expanded state to an expanded state. The fabric layers are stacked one above another and are aligned in the first direction when the multilayer structure is disposed at the non-expanded state. The fabric layers are formed into a cell-like structure when the multilayer structure is disposed at the expanded state. The cell-like structure defines a plurality of cell holes that are arranged along a plane parallel to the first direction and that open in a second direction transverse to the first direction.

### BACKGROUND OF THE INVENTION

1. Field of the Invention

This invention relates to a multilayer fabric, more particularly to a multilayer fabric that is expandable from a non-expanded state to an expanded state.

2. Description of the Related Art

With the progress of material technologies, light and high stiffness composite materials, for example, a sandwich composite material, are widely used in the fields of aviation, architecture, etc.

A conventional sandwich composite material can include upper and lower layers, and a core layer. The upper and lower layers mostly are made from high strength and high modulus fiber reinforced composite materials, and the core layer is made from one of soft plastics, hard plastics, foaming materials, wood, metal with a honeycomb structure, and the like. The metal honeycomb structure is formed by combining a plurality of metal sheets through an adhesive. However, the conventional sandwich composite material is disadvantageous in that the metal honeycomb structure is likely to deteriorate after a period of time.

### SUMMARY OF THE INVENTION

Therefore, an object of the present invention is to provide a multilayer fabric that can overcome the aforesaid drawback associated with the prior art.

Accordingly, a multilayer fabric of the present invention comprises a multilayer structure including a plurality of interwoven fabric layers. The multilayer structure is expandable in a first direction from a non-expanded state to an expanded state. The fabric layers are stacked one above another and are aligned in the first direction when the multilayer structure is disposed at the non-expanded state. The fabric layers are formed into a cell-like structure when the multilayer structure is disposed at the expanded state. The cell-like structure defines a plurality of cell holes that are arranged along a plane parallel to the first direction and that open in a second direction transverse to the first direction.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a fragmentary perspective view of the first preferred embodiment of a multilayer fabric according to the present invention;

FIG. 2 is a schematic view of the first preferred embodiment in a state where the multilayer fabric is disposed at a non-expanded state;

FIG. 3 is a schematic view of the first preferred embodiment in a state where the multilayer fabric is disposed at an expanded state;

FIG. 4 is a schematic view of a first segment of a fabric layer of the first preferred embodiment;

FIG. 5 is a schematic view of a first segment of a fabric layer of the second preferred embodiment of the multilayer fabric according to the present invention; and

FIG. 6 is a schematic view of a first segment of a fabric layer of the third preferred embodiment of the multilayer fabric according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

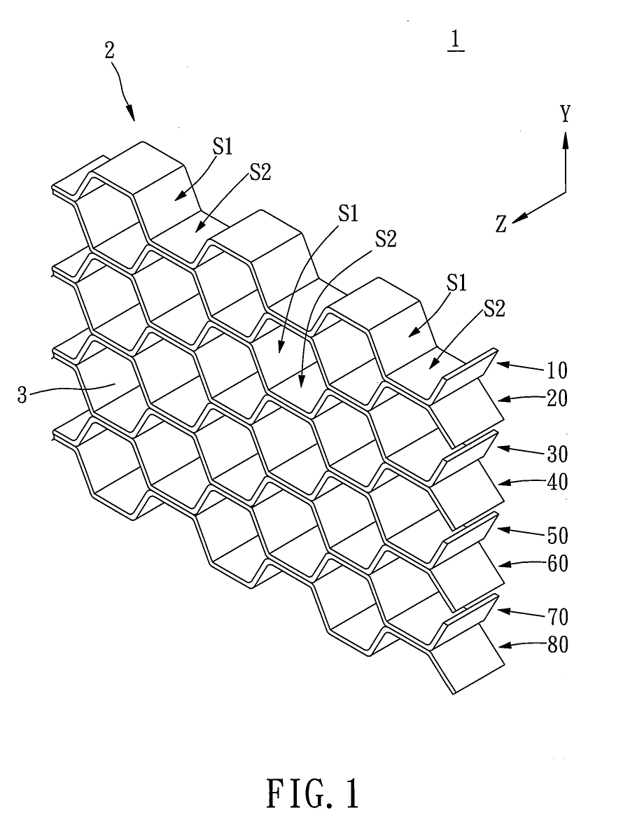

Referring to FIG. 1, a multilayer fabric of the present invention is shown to include a multilayer structure 1 having a plurality of interwoven fabric layers 10, 20, 30, 40, 50, 60, 70, and 80.

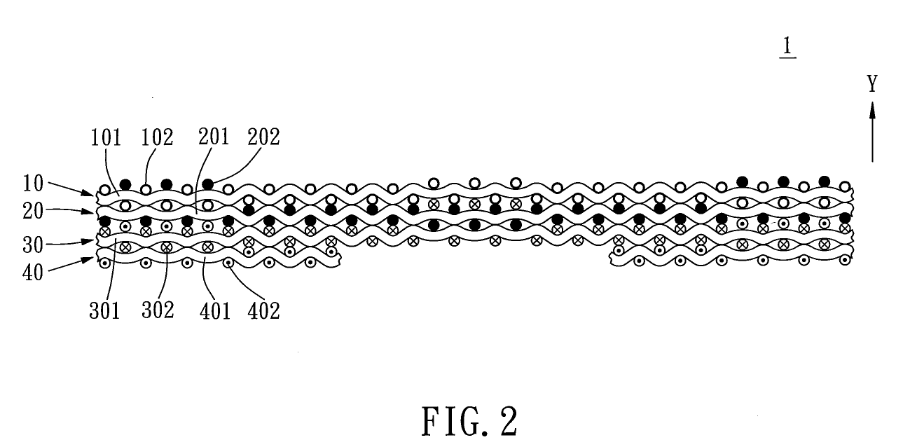

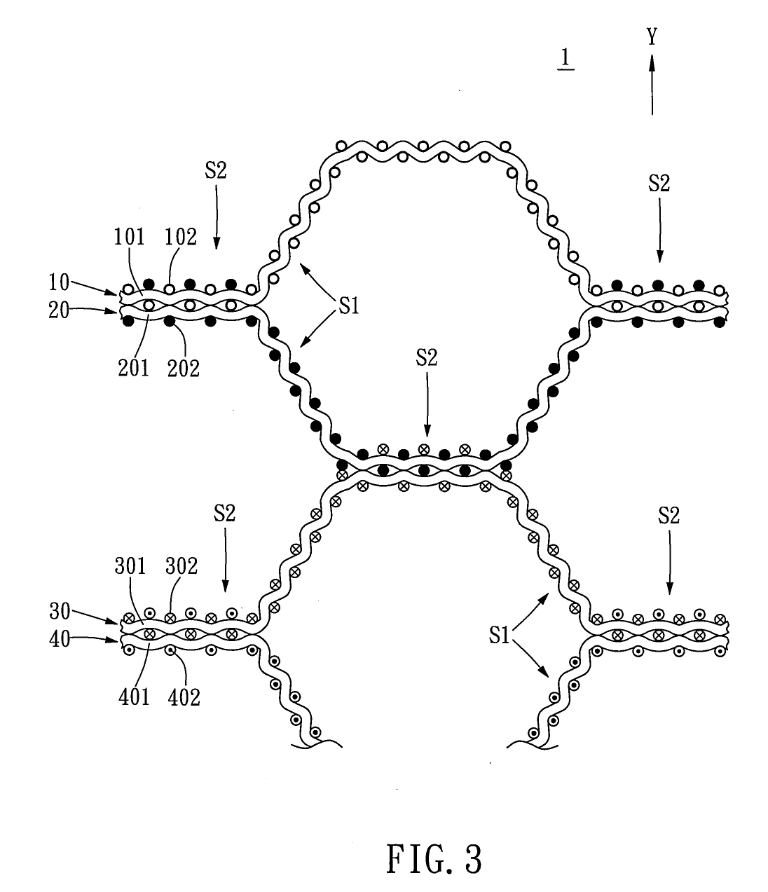

The multilayer structure 1 is expandable in a first direction (Y) from a non-expanded state (see FIG. 2) to an expanded state (see FIG. 3). The fabric layers 10, 20, 30, 40, 50, 60, 70, and 80 are stacked one above another and are aligned in the first direction (Y) when the multilayer structure 1 is disposed at the non-expanded state.

The fabric layers 10, 20, 30, 40, 50, 60, 70, and 80 are formed into a cell-like structure 2 when the multilayer structure 1 is disposed at the expanded state. The cell-like structure 2 defines a plurality of cell holes 3 that are arranged along a plane parallel to the first direction (Y) and that open in a second direction (Z) transverse to the first direction (Y).

In the preferred embodiment, each of the fabric layers 10, 20, 30, 40, 50, 60, 70, and 80 has a plurality of first segments (S1) and a plurality of second segments (S2) disposed alternately with the first segments (S1)

For the sake of brevity, since the structural connections between each two adjacent ones of the fabric layers 10, 20, 30, 40, 50, 60, 70, and 80 are similar, only the fabric layers 20, 30 and their two adjacent fabric layers 10, 40 are shown in FIGS. 2 and 3 and are described as follows.

As best shown in FIG. 3, the second segments (S2) of the fabric layer 20 interweave alternately with the second segments (S2) of the two adjacent fabric layers 10, 30.

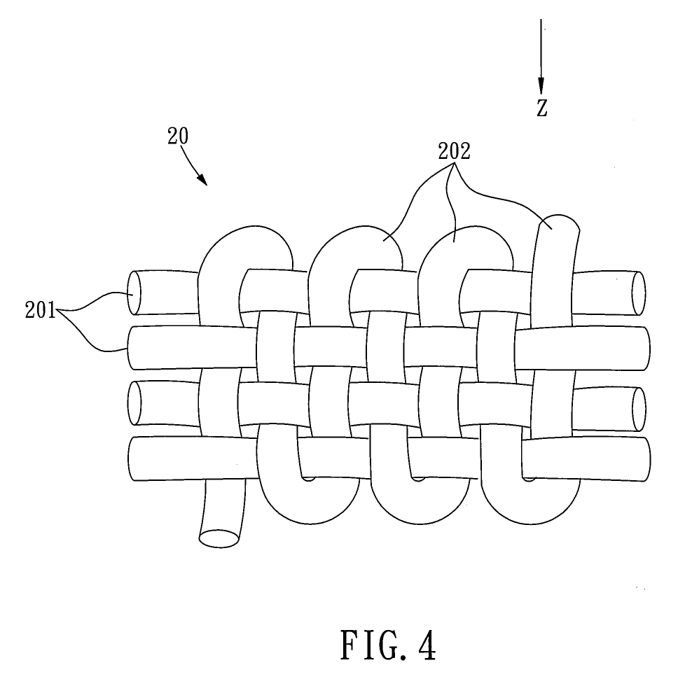

Preferably, as best shown in FIGS. 3 and 4, each of the fabric layers 20 (10, 30, 40) includes a plurality of warp yarns 201 (101, 301, 401) and at least one weft yarn 202 (102, 302, 402). Each of the first and second segments (S1, S2) of each of the fabric layers 20 (10, 30, 40) is composed of a portion of the warp yarns 201 (101, 301, 401) and a portion of the weft yarn 202 (102, 302, 402) of a respective one of the fabric layers 20 (10, 30, 40). The weft yarn 202 (102, 302, 402) and the warp yarns 201 (101, 301, 401) of each of the first segments (S1) of each of the fabric layers 20 (10, 30, 40) are interlocked together. In other words, the weft yarn 202 and the warp yarns 201 of the same fabric layer 20 are interlocked together at the first segments (S1).

The weft yarn 202 (102, 302, 402) and the warp yarns 201 (101, 301, 401) of each of the second segments (S2) of each of the fabric layers 20 (10, 30, 40) and the warp yarns 101 (301) of the respective one of the second segments (S2) of a respective one of the two adjacent ones of the fabric layers 10 (30) are interlocked together. In other words, the weft yarn 202 and the warp yarns 201 of the same fabric layer 20 are interlocked with the warp yarns 101 or 301 of the fabric layer 10 or the fabric layer 30 at the second segments (S2).

Moreover, the cell-like structure 2 is honeycomb in shape. Each of the fabric layers 10, 20, 30, 40, 50, 60, 70, and 80 is made from a material of carbon fiber, glass fiber, or polymeric fibers.

In a first preferred embodiment, as shown in FIGS. 1 and 4, each of the fabric layers 20 (10, 30, 40, 50, 60, 70, and 80) has a weaving structure of plain weave.

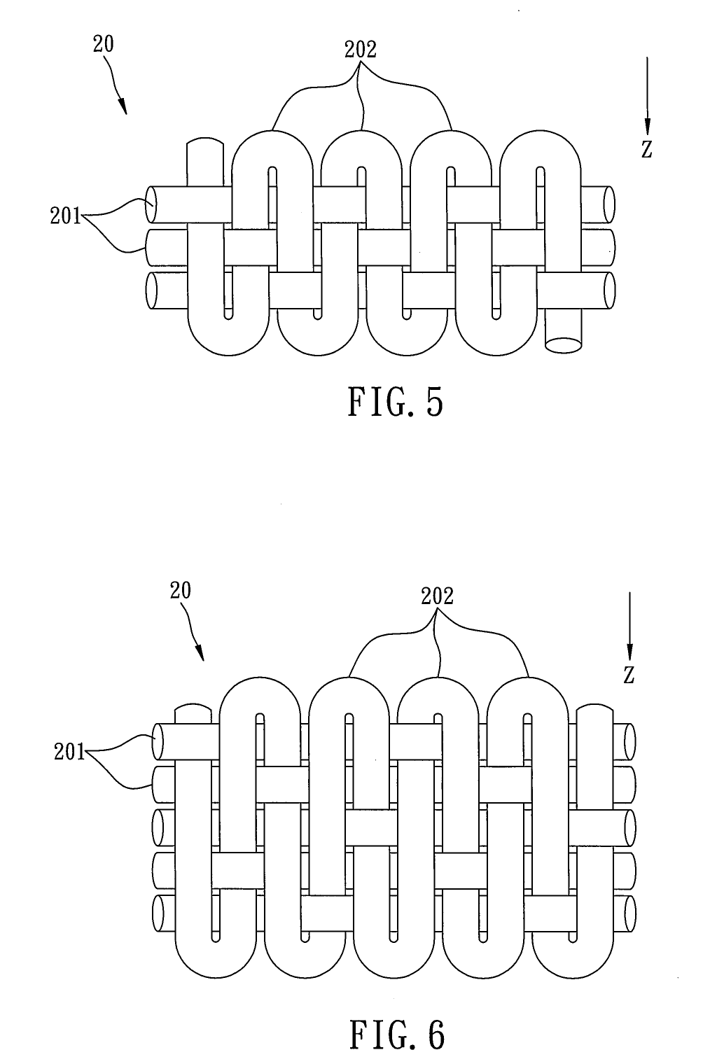

In a second preferred embodiment, as shown in FIGS. 1 and 5, each of the fabric layers 20 (10, 30, 40, 50, 60, 70, and 80) has a weaving structure of twill weave.

In a third preferred embodiment, as shown in FIGS. 1 and 6, each of the fabric layers 20 (10, 30, 40, 50, 60, 70, and 80) has a weaving structure of satin weave.

With the fabric layers 10, 20, 30, 40, 50, 60, 70, and 80 of the multilayer fabric of the present invention formed into the cell-like structure 2, the aforesaid drawback associated with the prior art can be eliminated. Therefore, the structure of the sandwich composite material would be enhanced by the multilayer fabric of the present invention. Furthermore, the multilayer fabric can be used in the field of filter materials, honeycomb boards, antimagnetic shield materials, thermal insulation materials, and outer covers, floor, or partitions of aircrafts.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A multilayer fabric comprising:
a multilayer structure including a plurality of interwoven fabric layers;
wherein said multilayer structure is expandable in a first direction from a non-expanded state to an expanded state, said fabric layers being stacked one above another and aligned in the first direction when said multilayer structure is disposed at the non-expanded state; and
wherein said fabric layers are formed into a cell-like structure when said multilayer structure is disposed at the expanded state, said cell-like structure defining a plurality of cell holes that are arranged along a plane parallel to the first direction and that open in a second direction transverse to the first direction.

2. The multilayer fabric of claim 1, wherein each of said fabric layers has a plurality of first segments and a plurality of second segments disposed alternately with said first segments, said second segments of each of said fabric layers interweaving alternately with said second segments of two adjacent ones of said fabric layers.

3. The multilayer fabric of claim 2, wherein each of said fabric layers includes a plurality of warp yarns and at least one weft yarn, each of said first and second segments of each of said fabric layers being composed of a portion of said warp yarns and a portion of said weft yarn of a respective one of said fabric layers, said weft yarn and said warp yarns of each of said first segments of each of said fabric layers being interlocked together, said weft yarn and said warp yarns of each of said second segments of each of said fabric layers and said warp yarns of the respective one of said second segments of a respective one of said two adjacent ones of said fabric layers being interlocked together.

4. The multilayer fabric of claim 1, wherein said cell-like structure is honeycomb in shape.

5. The multilayer fabric of claim 1, wherein each of said fabric layers has a weaving structure selected from one of plain weave, twill weave, and satin weave.

6. The multilayer fabric of claim 1, wherein each of said fabric layers is made from a material selected from one of carbon fiber, glass fiber, and polymeric fibers.
